(19) United States
(12) Patent Application Publication
(10) Pub. No.: US 2004/0081330 A1
(43) Pub. Date: Apr. 29, 2004

(54) Speaker with cabinet

(76) Inventor: Hsi-Chung Lin, Shindian City (TW)

Correspondence Address: BIRCH STEWART KOLASCH & BIRCH, PO BOX 747, FALLS CHURCH, VA, 22040-0747, US

(21) Appl. No.: 10/277,808

(22) Filed: Oct. 23, 2002

(51) Int. Cl. H04R 1/02; H04R 1/20

(52) U.S. Cl. 381/345; 381/353

(57) ABSTRACT

A speaker with cabinet structure includes a frame in a close ring can be in any shape with inner fasten brim on circumference, a diaphragm located on front of frame, a dust proof cap is on the center of the diaphragm; a voice coil is beneath the diaphragm, an insulation ring is under the voice coil, an iron core and a magnet is also under insulation ring, a pressing ring fastens the diaphragm onto the inner fasten brim, the frame is placed on the open of a box with corresponding shape to form a sealed space inside box to bounce the diaphragm back. When the diaphragm vibrates, the sealed air inside the speaker box can perform the best frequency response, functions like a acoustic cabinet and avoid the damper, he sealed space can achieve the waterproof and moisture proof effect, the structure is simpler for lower manufacturing cost.

### BACKGROUND OF THE INVENTION

I. Field of the Invention

This invention relates generally to a speaker with cabinet structure and, more specifically, to a speaker with cabinet structure that vibrates the sealed air inside the speaker box for the best frequency response and functions like a acoustic cabinet and avoid the damper to achieve the waterproof and moisture proof effect, the structure is simpler for lower manufacturing cost.

II. Description of the Prior Art

Heretofore, it is known that a regular speaker (a) for home appliances, as shown in FIG. 6, is made of a frame (a1) with a diaphragm (a2) on top, a voice coil (a3) is in the center of the frame (a1), a dust-proof cap (a4) is on top of the voice coil (a3), an insulation ring (a5) is beneath the voice coil (a3), a T iron (a6) is under the insulation ring (a5), a magnet ring (a7) is inside the T iron (a6), a damper (a8) is inside of the frame (a1) and beneath the diaphragm (a2) to pull back the diaphragm (a2) after vibration; the speaker (a) are installed inside the rectangular cabinet or inside the doors of an automobile depends on different applications.

A speaker has to be installed inside an empty cabinet for better sound quality, however most of the appliances equipped with speakers do not have such consideration and design, therefore most of those small speakers can not have good sound quality.

Most of the known speaker (a) do not have waterproof design, therefore they have poor waterproof and moisture proof capability, the speaker (a) might not have good sound quality because of moisture.

Most of the known speaker (a) have too many components that introduces inconvenience in assembly, the manufacturing cost is higher that reduces the competition in market.

### SUMMARY OF THE INVENTION

It is therefore a primary object of the invention to provide a speaker with cabinet structure that offers best frequency response and avoid the need of a damper, at the same time to achieve the water-proof and moisture-proof effect.

In order to achieve the objective set forth, a speaker with cabinet structure in accordance with the present invention comprises a frame in arbitrary shape in front of a box with inner fasten brim on circumference, a diaphragm located on front of the frame, a dust proof cap is on the center of the diaphragm; a voice coil is beneath the diaphragm, an insulation ring is under the voice coil, an iron core and a magnet is also under the insulation ring; a pressing ring fastens the diaphragm onto the inner fasten brim, the frame is placed on the open of a box with corresponding shape to form a sealed space inside said box to bounce the diaphragm back. When the diaphragm vibrates, the sealed air inside the speaker box can perform the best frequency response and function like a acoustic cabinet to avoid the damper, he sealed space can achieve the waterproof and moisture proof effect, the structure is simpler for lower manufacturing cost.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is an explosive view of the present invention;

FIG. 3 is a cross-sectional view of the present invention;

FIG. 4 is a cross-sectional view of another embodiment of the present invention;

FIG. 5 is a cross-sectional view of a further embodiment of the present invention;

FIG. 6 is a cross-sectional view of the prior art.

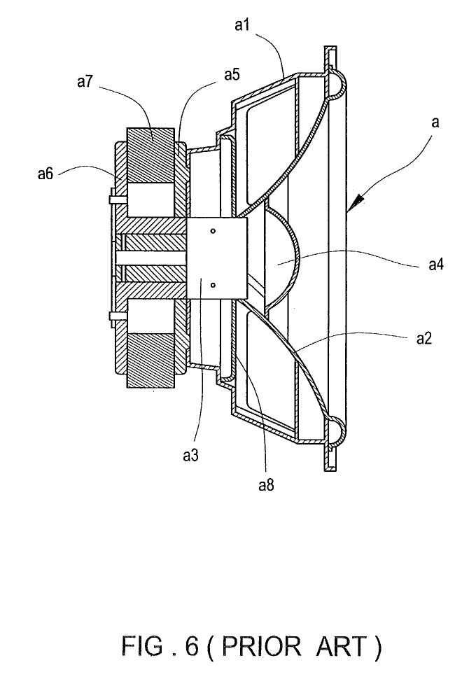

### DESCRIPTION OF THE PREFERRED EMBODIMENT

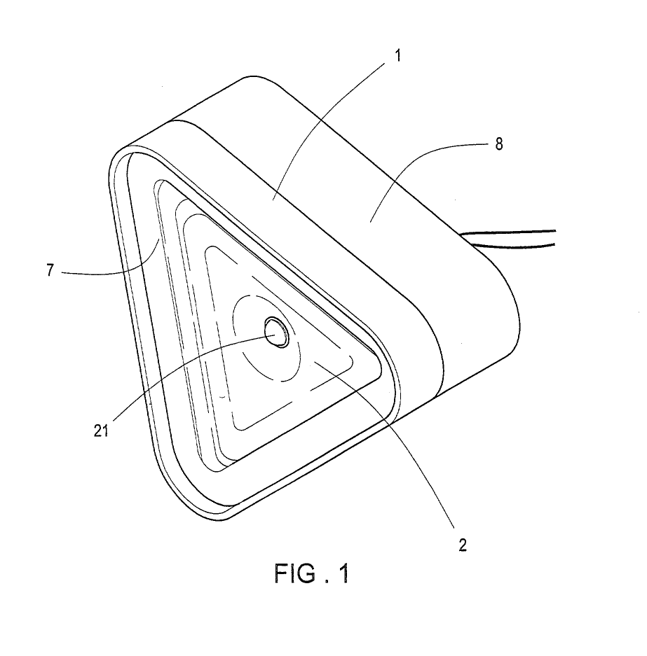

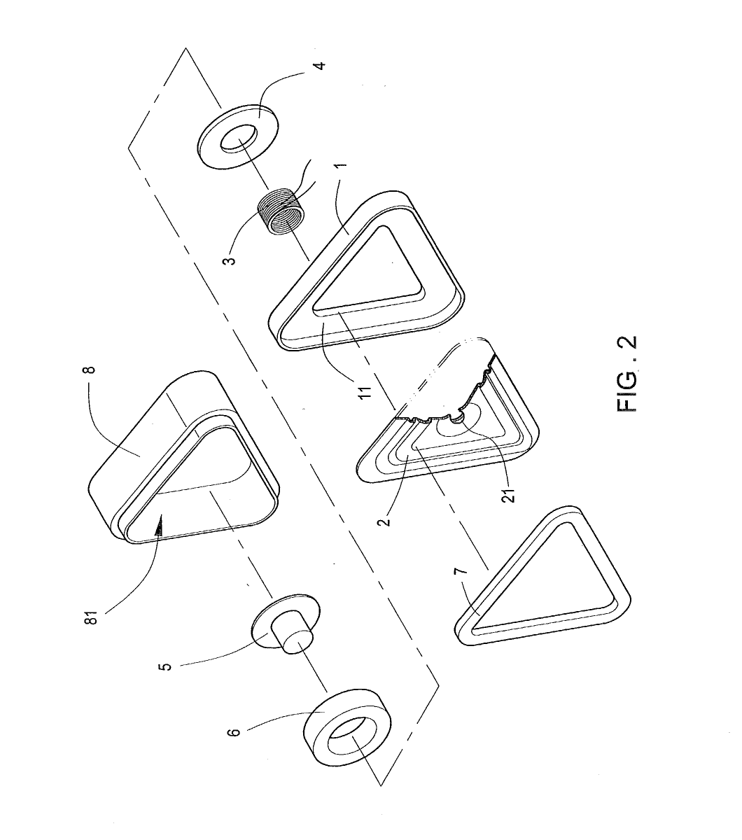

Referring to FIG. 1 and FIG. 2, the present invention is composed of a frame (1) with a diaphragm (2) on front, a dust proof cap (21) is on the center of the diaphragm (2); a voice coil (3) is beneath the diaphragm (2), an insulation ring (4) is under the voice coil (3); an iron core (5) and a magnet (6) is under the insulation ring (4). The functions of each component are described below:

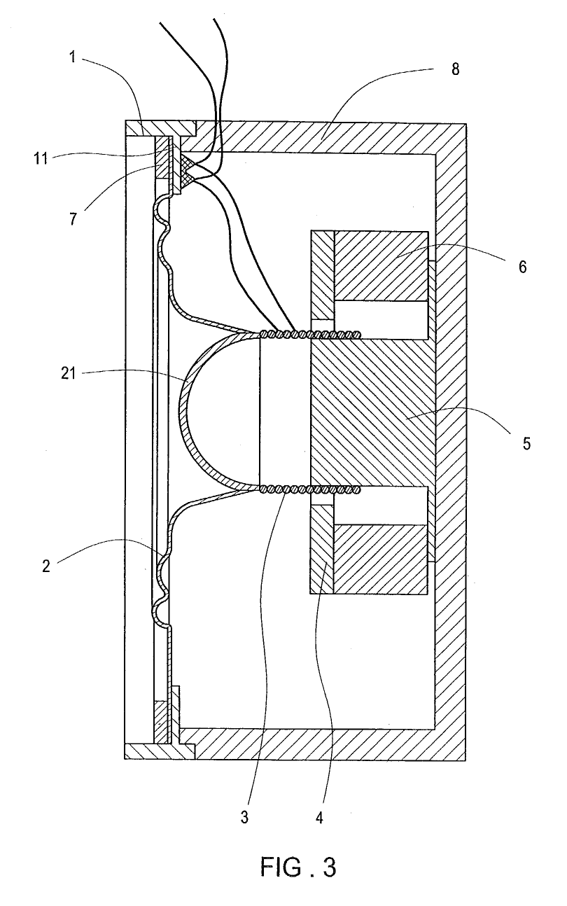

The frame (1) is a close ring can be in any shape with the inner fasten brim (11) on circumference, a pressing ring (7) fastens the diaphragm (2) onto the inner fasten brim (11) of the frame (1). The frame (1) is placed on the open (81) of a box (8) with corresponding shape, as shown in FIG. 3, the arrangement forms a sealed space inside the box (8) to bounce the diaphragm (2) back, this scheme not only makes the frequency response of the speak perform best but also achieve water proof and moisture proof effect.

Based on above description, the diaphragm (2) covers the open (81) of the box (8) to form a sealed space, air is confined inside the box (8), therefore when the diaphragm (2) moves either inward or outward, the air sealed inside the box (8) can pull the diaphragm (2) back, this structure can avoid an extra damper as prior art for simpler mechanism and lower manufacturing cost.

The diaphragm (2) is installed onto the open (81) of the box (8) instead of the frame as the prior art, such scheme is in a simpler structure to save manufacturing cost.

The box (8) acts as an acoustic box for best frequency response; the diaphragm (2) covers the open (81) of the box (8) to form a sealed space for best water proof and moisture proof effect, the whole body can avoid damage from moisture.

The box (8) forms a sealed space; the sealed space can not only replace sound absorbent material for lower manufacturing cost but also achieve the best frequency response for best sound effect.

The present invention simplifies the structure for easier assembly to lower the manufacturing cost for better market competition.

The box (8) can be in arbitrary shape for different requirement to meet different market demands.

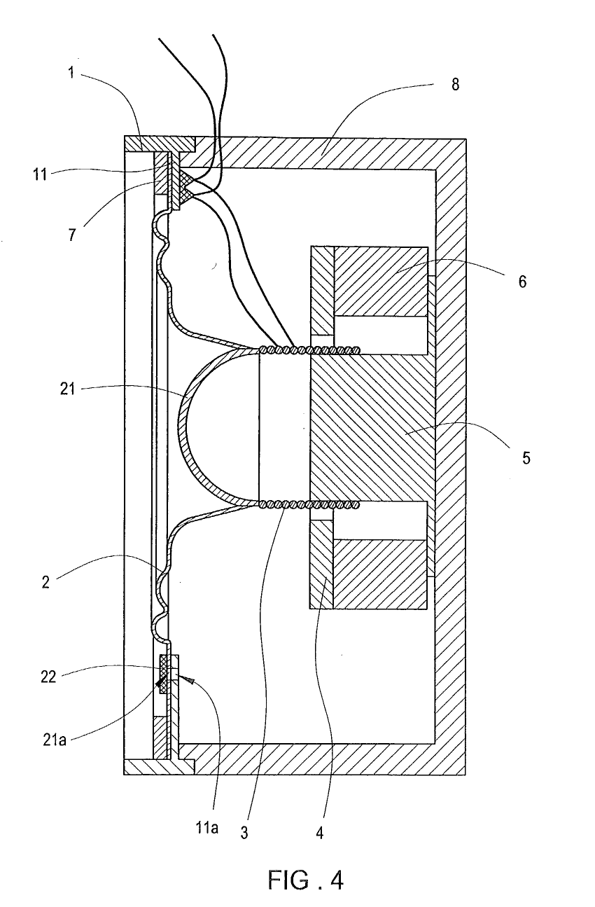

An application example, referring to FIG. 4, a through hole (11a) is on the inner fasten brim (11) of the frame (1), a corresponding open hole (21a) is on the diaphragm (2), a water proof sound adjusting cloth (22) sticks on the open hole (21a) of the diaphragm (2) to adjust the air pressure inside the box (8), such scheme can make the small speakers perform low frequency sound effect that the known small speakers can not achieve.

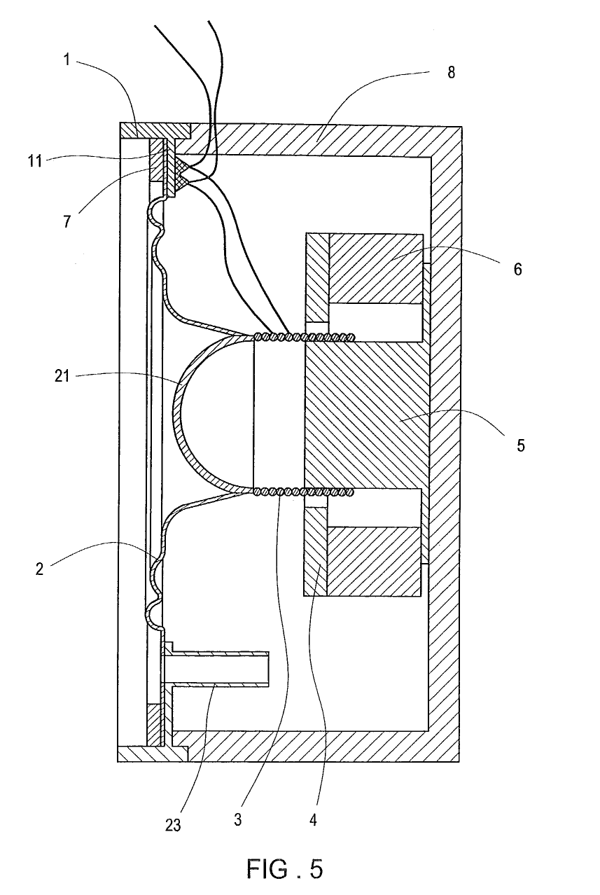

Another application example, referring to FIG. 5, a sound guide tube (23) is on the inner fasten brim (11) of the frame (1), the sound guide tube (23) stretches into the box (8) to make the small speakers perform low frequency sound.

While a preferred embodiment of the invention has been shown and described in detail, it will be readily understood and appreciated that numerous omissions, changes and additions may be made without departing from the spirit and scope of the invention.

What is claimed is:

1. A speaker with cabinet structure comprising:
a diaphragm with a dust proof cap on the center thereof is disposed on the front end of a frame, a voice coil being disposed under said diaphragm, an insulation ring being installed under said voice coil, an iron core and a magnet located under said insulation ring,
wherein said frame is in a circular form with an inner fasten brim on inner circumference thereof; a pressing ring fastens said diaphragm onto said inner fasten brim of said frame while said frame is placed on an open of a box with corresponding shape to form a sealed space inside said box to bounce said diaphragm back.

2. The speaker with cabinet structure recited in claim 1, wherein a through hole is located on said inner fasten brim of said frame, a corresponding open hole is located on said diaphragm, and a water proof sound adjusting cloth sticks on said open hole of said diaphragm.

3. The speaker with cabinet structure recited in claim 1, wherein a sound guide tube is disposed on said inner fasten brim of said frame and said sound guide tube stretches into said box.
